(19) United States
(12) Patent Application Publication
(10) Pub. No.: US 2026/0266661 A1
(43) Pub. Date: Sep. 10, 2026

(54) INTERFERENCE MEASUREMENT DEVICE AND INTERFERENCE MEASUREMENT METHOD

(71) Applicant: HAMAMATSU PHOTONICS K.K., Hamamatsu-shi, Shizuoka (JP)

(72) Inventors: Hisanari TAKAHASHI, Shizuoka (JP); Naoya KAWAI, Shizuoka (JP); Hiroshi SATOZONO, Shizuoka (JP)

(73) Assignee: HAMAMATSU PHOTONICS K.K., Hamamatsu-shi, Shizuoka (JP)

(21) Appl. No.: 19/167,486

(22) PCT Filed: Jan. 25, 2024
(86) PCT No.: PCT/JP2024/002291

§ 371 Date: Sep. 22, 2025

(30) Foreign Application Priority Data
Mar. 24, 2023 (JP) 2023-047799

(51) Int. Cl. G01J 3/453; G01J 3/42; G01N 21/3586

(52) U.S. Cl. CPC G01J 3/4531; G01J 3/42; G01N 21/3586

(57) ABSTRACT

An interference measurement apparatus includes a light source, an interference optical system, a photomultiplier tube, an interference intensity measurement unit, an electric field amplitude calculation unit, and an analysis unit. The light source outputs light in a band in which the photomultiplier tube has sensitivity. The photomultiplier tube has sensitivity in a band of light including a terahertz wave, and outputs an electrical signal. The electric field amplitude calculation unit, based on a relationship between a value of an electric field amplitude of light incident on the photomultiplier tube and a value of the electrical signal output from the photomultiplier tube, converts a value of an intensity of interference light into a value of an electric field amplitude, and obtains the value of the electric field amplitude of the interference light for each value of a time difference corresponding to an optical path length difference.

### TECHNICAL FIELD

The present disclosure relates to an interference measurement apparatus and an interference measurement method.

### BACKGROUND ART

A terahertz wave is light in a band of an intermediate region between light waves and radio waves (a band with a frequency around 1 THz), and it has a characteristic absorption spectrum for an analysis target object such as a drug, which is not observed in other wavelength bands, and thus, its application to identification of the analysis target object and the like is expected. Various techniques are known as the analysis technique using terahertz waves.

Terahertz time domain spectroscopy (THz-TDS) is a technique in which a temporal waveform of the terahertz wave which is transmitted through, reflected by, or totally reflected by the analysis target object is measured, and by performing a Fourier transform on a temporal waveform of an electric field amplitude of the terahertz wave obtained by the above measurement, the analysis of the analysis target object can be performed (Non Patent Document 1). Hereinafter, the above technique is referred to as a “first related art”. In the first related art, a lock-in amplifier is used for the measurement of the temporal waveform of the terahertz wave.

By using a terahertz wave light source in which an output wavelength is variable, and dispersing and detecting the terahertz wave which is transmitted through, reflected by, or totally reflected by the analysis target object, the analysis of the analysis target object can be performed (Non Patent Document 2). Hereinafter, the above technique is referred to as a “second related art”. In the second related art, a thermal detector is used for the detection of the terahertz wave.

Further, by performing Fourier spectroscopy by interference measurement using the terahertz wave, based on a measurement principle similar to that of Fourier transform infrared spectroscopy (FTIR), the analysis of the analysis target object can also be performed (Non Patent Document 3). Hereinafter, the above technique is referred to as a “third related art”. In the third related art, a thermal detector is used for the detection of the interference of the terahertz wave.

### CITATION LIST

### Patent Literature

Patent Document 1: Japanese Patent Application Laid-Open Publication No. 2022-538534

### Non Patent Literature

Non Patent Document 1: Jens Neu et al., “Tutorial: An introduction to terahertz time domain spectroscopy (THz-TDS)”, J. Appl. Phys., 124, 231101 (2018), pp. 231101-1-231101-14
Non Patent Document 2: K. Murate et al., “Perspective: Terahertz wave parametric generator and its applications”, J. Appl. Phys., 124, (2018), pp. 160901-1-160901-10
Non Patent Document 3: Masashi Yamaguchi et al., “Terahertz wave generation in nitrogen gas using shaped optical pulses”, J. Opt. Soc. Am. B, Vol. 26, No. 9 (2009), pp. A90-A94
Non Patent Document 4: Simon Lehnskov Lange et al., “Ultrafast THz-driven electron emission from metal metasurfaces”, J. Appl. Phys., 128, 070901 (2020), pp. 070901-1-070901-21

### SUMMARY OF INVENTION

### Technical Problem

In the first related art described above, when measuring the temporal waveform of the terahertz wave, a long integration time by the lock-in amplifier is required. Further, in the second and third related arts described above, the thermal detector having a slow response is used, and thus, a measurement time is long. Conventional analysis techniques using the terahertz waves, including the above first to third related arts, require a long time for the measurement.

The present inventors, in the course of researching high-speed analysis techniques using the terahertz waves, considered using a photomultiplier tube which is described in Patent Document 1. The photomultiplier tube described in Patent Document 1 can have sensitivity in a band of light including the terahertz waves, and can output an electrical signal having a value according to an incident light intensity.

The above photomultiplier tube includes an electron emission unit for emitting electrons by light incidence, an electron multiplier unit for multiplying the emitted electrons, and a signal output unit for collecting the multiplied electrons and outputting as a current signal or as an optical image converted by a phosphor. The electron emission unit, the electron multiplier unit, and the signal output unit described above are arranged inside a housing whose interior is maintained in a vacuum. A window portion is provided in the housing, and light passed through the window portion is incident on the electron emission unit.

The electron emission unit has a configuration in which a metamaterial structure (a metasurface) corresponding to the band of the light of a detection target is formed on a principal surface of a substrate, and can emit photoelectrons by the light incidence onto the metasurface. The electron multiplier unit includes a plurality of stages of dynodes or a microchannel plate. In the case in which the electron multiplier unit includes the microchannel plate, imaging of an incident light intensity distribution is possible.

The present inventors, by using the above photomultiplier tube in place of the thermal detector in the configuration of the third related art, found the possibility of speeding up the Fourier spectroscopy by the interference measurement using the terahertz wave, and further, on the other hand, they also found that simply performing the same processing as the conventional FTIR on the output signal from the photomultiplier tube described above does not allow accurate analysis of the analysis target object.

The present invention has been made based on the findings of the present inventors described above, and an object of the present invention is to provide an interference measurement apparatus and an interference measurement method capable of performing Fourier spectroscopy by interference measurement using a terahertz wave rapidly and accurately.

### Solution to Problem

An embodiment of the present invention is an interference measurement apparatus. The interference measurement apparatus includes (1) a photomultiplier tube having sensitivity in a band of light including a terahertz wave, and for outputting an electrical signal having a value according to an incident light intensity; (2) a light source for outputting light in the band in which the photomultiplier tube has the sensitivity; (3) an interference optical system for splitting the light output from the light source into first split light and second split light, combining the first split light passed through an analysis target object and the second split light, and causing combined light to be incident on the photomultiplier tube, and in which an optical path length difference between the first split light and the second split light is variable; (4) an interference intensity measurement unit for measuring an intensity of interference light generated by the first split light and the second split light incident on the photomultiplier tube based on the electrical signal output from the photomultiplier tube; (5) an electric field amplitude calculation unit for, based on a relationship between a value of an electric field amplitude of the light incident on the photomultiplier tube and a value of the electrical signal output from the photomultiplier tube, converting a value of the intensity of the interference light measured by the interference intensity measurement unit into the value of the electric field amplitude, and obtaining the value of the electric field amplitude of the interference light for each value of a time difference corresponding to the optical path length difference; and (6) an analysis unit for analyzing the analysis target object by performing a Fourier transform based on a dependence of the value of the electric field amplitude of the interference light obtained by the electric field amplitude calculation unit on the value of the time difference.

An embodiment of the present invention is an interference measurement method. The interference measurement method is a method for analyzing an analysis target object using (1) a photomultiplier tube having sensitivity in a band of light including a terahertz wave, and for outputting an electrical signal having a value according to an incident light intensity; (2) a light source for outputting light in the band in which the photomultiplier tube has the sensitivity; and (3) an interference optical system for splitting the light output from the light source into first split light and second split light, combining the first split light passed through the analysis target object and the second split light, and causing combined light to be incident on the photomultiplier tube, and in which an optical path length difference between the first split light and the second split light is variable, and the method includes (4) an interference intensity measurement step of measuring an intensity of interference light generated by the first split light and the second split light incident on the photomultiplier tube based on the electrical signal output from the photomultiplier tube; (5) an electric field amplitude calculation step of, based on a relationship between a value of an electric field amplitude of the light incident on the photomultiplier tube and a value of the electrical signal output from the photomultiplier tube, converting a value of the intensity of the interference light measured in the interference intensity measurement step into the value of the electric field amplitude, and obtaining the value of the electric field amplitude of the interference light for each value of a time difference corresponding to the optical path length difference; and (6) an analysis step of analyzing the analysis target object by performing a Fourier transform based on a dependence of the value of the electric field amplitude of the interference light obtained in the electric field amplitude calculation step on the value of the time difference.

### Advantageous Effects of Invention

According to the embodiments of the present invention, it is possible to perform Fourier spectroscopy by interference measurement using a terahertz wave rapidly and accurately.

### BRIEF DESCRIPTION OF DRAWINGS

FIG. 1 is a diagram illustrating a configuration example of an interference measurement apparatus.

FIG. 2 is a diagram illustrating another configuration example of the interference measurement apparatus.

FIG. 3 is a block diagram illustrating a configuration of a photomultiplier tube 30.

FIG. 4 is a graph showing a relationship between an intensity of interference light measured by an interference intensity measurement unit 40 based on an electrical signal output from the photomultiplier tube 30 and a time difference Δt.

FIG. 5 is a graph showing a relationship between the intensity of the interference light and the time difference Δt which is shown in Non Patent Document 3.

FIG. 6 includes (a) a graph showing input-output characteristics of the photomultiplier tube 30, and (b) a graph showing time dependence of a voltage signal V output from the photomultiplier tube 30.

FIG. 7 includes (a) a graph showing dependence of Vp-p on an optical path length difference Δd, and (b) a graph showing dependence of Vp-p on the time difference Δt.

FIG. 8 includes (a) a graph showing dependence of an electric field amplitude E of the interference light on the time difference Δt, and (b) a diagram showing an amplitude spectrum and a phase spectrum of the electric field amplitude E of the interference light.

FIG. 9 is a graph showing a relationship (the FN equation) between an output value V of the photomultiplier tube 30 and the electric field amplitude E of the incident terahertz wave which is obtained by fitting processing.

FIG. 10 is a table describing a correspondence example between the electric field amplitude E of the incident terahertz wave and the output value V of the photomultiplier tube 30 which is calculated by using the FN equation.

FIG. 11 includes (a) a graph showing dependence of the electric field amplitude E of the interference light on the time difference Δt, and (b) a graph showing the phase spectrum of the electric field amplitude E of the interference light.

FIG. 12 includes (a) a graph showing the amplitude spectrum of the electric field amplitude E of the interference light, (b) a graph showing a spectrum of an absorption coefficient α(ω), and (c) a graph showing a spectrum of a refractive index n(ω).

FIG. 13 is a graph showing a relationship between the output value V of the photomultiplier tube 30 and the electric field amplitude E of the incident terahertz wave.

### DESCRIPTION OF EMBODIMENTS

Hereinafter, embodiments of an interference measurement apparatus and an interference measurement method will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

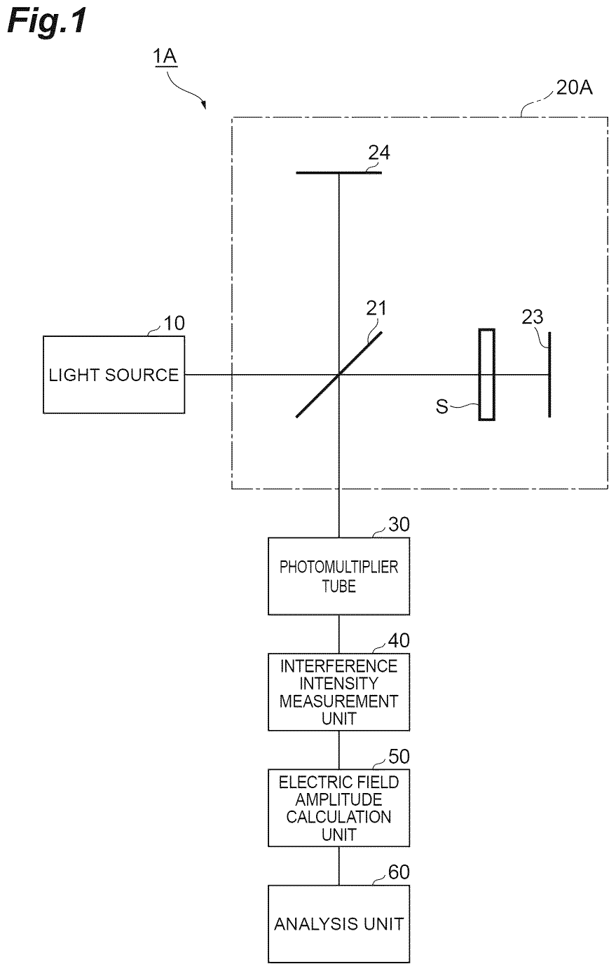

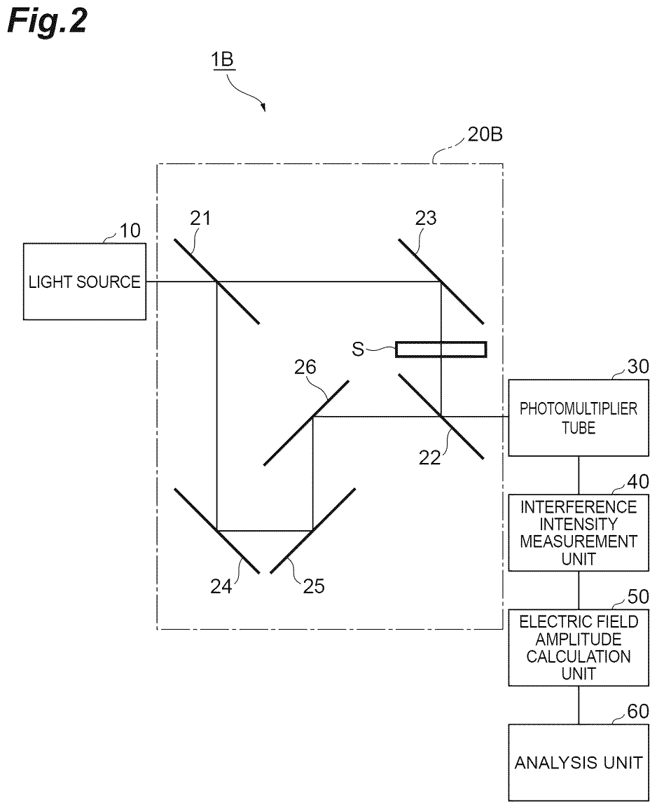

An interference measurement apparatus of the present embodiment can be configured to have a configuration of an interference measurement apparatus 1A (FIG. 1), or a configuration of an interference measurement apparatus 1B (FIG. 2) as described below.

FIG. 1 is a diagram illustrating a configuration example of an interference measurement apparatus. The interference measurement apparatus 1A illustrated in this diagram includes a light source 10, an interference optical system 20A, a photomultiplier tube 30, an interference intensity measurement unit 40, an electric field amplitude calculation unit 50, and an analysis unit 60.

The light source 10 outputs light in a band (a band of light including a terahertz wave) in which the photomultiplier tube 30 has sensitivity. The light output from the light source 10 may be pulsed light, or may be continuous light.

Examples of the light source capable of outputting the terahertz wave of the pulsed light include a configuration in which a femtosecond laser light source (for example, a Ti sapphire laser light source) and a nonlinear optical crystal (for example, ZnTe) are combined, an injection seeded THz parametric generator (is-TPG), and the like. Examples of the light source capable of outputting the terahertz wave of the continuous light include a resonant tunneling diode (RTD), an impact avalanche and transit time diode (IMPATT diode), a quantum cascade laser light source, a THz gas laser light source, and the like.

The interference optical system 20A includes a beam splitter 21, a mirror 23, and a mirror 24, and has a configuration of a Michelson interferometer. The beam splitter 21 splits the light output from the light source 10 into two beams of first split light and second split light, outputs the first split light of one split light to the mirror 23, and outputs the second split light of the other split light to the mirror 24. Further, the beam splitter 21 inputs the first split light reflected by the mirror 23, inputs the second split light reflected by the mirror 24, combines the first split light and the second split light input as described above, and outputs combined light to the photomultiplier tube 30. The beam splitter 21 may be formed of, for example, silicon or an ITO mirror.

An analysis target object S is disposed on an optical path of the first split light between the beam splitter 21 and the mirror 23. The analysis target object S may be disposed on an optical path of the second split light. Both or any one of the mirror 23 and the mirror 24 can be moved in a direction perpendicular to a reflection surface, and as a result, an optical path length difference between the first split light and the second split light is set to be variable.

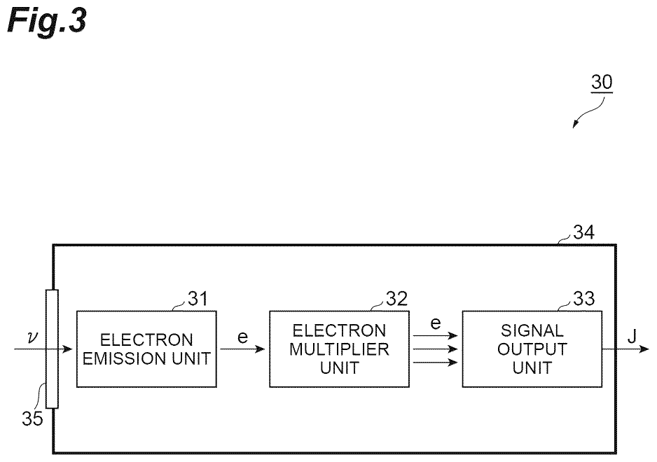

The photomultiplier tube 30 has the sensitivity in the band of the light including the terahertz wave, and outputs an electrical signal having a value according to an incident light intensity. The details of the photomultiplier tube 30 will be described later with reference to FIG. 3.

The interference intensity measurement unit 40 measures an intensity of interference light generated by the first split light and the second split light which are incident on the photomultiplier tube 30, based on the electrical signal output from the photomultiplier tube 30 (an interference intensity measurement step).

The electric field amplitude calculation unit 50, based on a relationship between a value of an electric field amplitude of the light incident on the photomultiplier tube 30 and a value of the electrical signal output from the photomultiplier tube 30, converts a value of the intensity V of the interference light measured by the interference intensity measurement unit 40 into the value of the electric field amplitude E, and obtains the value of the electric field amplitude E of the interference light for each value of a time difference Δt corresponding to the optical path length difference Δd (an electric field amplitude calculation step). The optical path length difference Δd corresponds to twice the difference of distances from the beam splitter to the respective two mirrors. There is a relationship of Δt=Δd/c between the optical path length difference Δd and the time difference Δt, in which c is the speed of light in a vacuum.

The analysis unit 60 analyzes the analysis target object S by performing a Fourier transform based on the dependence of the value of the electric field amplitude E of the interference light obtained by the electric field amplitude calculation unit 50 on the value of the time difference Δt (an analysis step).

The details of the processing performed by each of the interference intensity measurement unit 40, the electric field amplitude calculation unit 50, and the analysis unit 60 will also be described later.

An interference measurement method of the present embodiment is a method for analyzing the analysis target object S by using the light source 10, the interference optical system 20A, and the photomultiplier tube 30 described above, and includes the interference intensity measurement step, the electric field amplitude calculation step, and the analysis step.

FIG. 2 is a diagram illustrating another configuration example of the interference measurement apparatus. The interference measurement apparatus 1B illustrated in this diagram includes the light source 10, an interference optical system 20B, the photomultiplier tube 30, the interference intensity measurement unit 40, the electric field amplitude calculation unit 50, and the analysis unit 60. As compared with the configuration of the interference measurement apparatus 1A (FIG. 1), the interference measurement apparatus 1B (FIG. 2) is different in that the apparatus includes the interference optical system 20B instead of the interference optical system 20A.

The interference optical system 20B includes beam splitters 21 and 22, and mirrors 23 to 26, and has a configuration of a Mach-Zehnder interferometer. The beam splitter 21 splits the light output from the light source 10 into two beams of the first split light and the second split light, outputs the first split light of one split light to the mirror 23, and outputs the second split light of the other split light to the mirror 24. The second split light output to the mirror 24 is reflected respectively by the mirror 24, the mirror 25, and the mirror 26. The beam splitter 22 inputs the first split light reflected by the mirror 23, inputs the second split light reflected by the mirror 26, combines the first split light and the second split light input as described above, and outputs the combined light to the photomultiplier tube 30.

The analysis target object S is disposed on the optical path of the first split light from the beam splitter 21 through the mirror 23 to the beam splitter 22. The analysis target object S may be disposed on the optical path of the second split light. The mirror 24 and the mirror 25 can be moved, and as a result, the optical path length difference between the first split light and the second split light is set to be variable.

As compared with the Mach-Zehnder interferometer, the Michelson interferometer is preferable because the number of optical components (beam splitters and mirrors) is small, and a mechanism for making the optical path length difference variable is simple. Therefore, the configuration of the interference measurement apparatus 1A (FIG. 1) is more preferable than the configuration of the interference measurement apparatus 1B (FIG. 2).

FIG. 3 is a block diagram illustrating a configuration of the photomultiplier tube 30. The photomultiplier tube 30 has a configuration in which an electron emission unit 31, an electron multiplier unit 32, and a signal output unit 33 are arranged inside a housing 34 whose interior is maintained in a vacuum. The housing 34 is provided with a window portion 35.

The electron emission unit 31 emits electrons e by light incidence when the light ν transmitted through the window portion 35 is incident. The electron emission unit 31 is a photoelectric conversion unit designed to have the sensitivity in the band of the light including the terahertz wave of the detection target, and has, for example, a configuration in which a metamaterial structure (a metasurface) is formed on a principal surface of a substrate, and the electrons e can be emitted by the light incidence on the metasurface.

The electron multiplier unit 32 multiplies the electrons e emitted from the electron emission unit 31. The electron multiplier unit 32 includes a plurality of stages of dynodes or a microchannel plate. An electron multiplication factor in the electron multiplier unit 32 depends on the voltage applied to the plurality of stages of dynodes or the microchannel plate.

The signal output unit 33 collects the electrons e multiplied by the electron multiplier unit 32, and outputs them as a current signal J. The interference intensity measurement unit 40 may input the current signal J output from the signal output unit 33, or may input a voltage signal obtained by converting the current signal J into the voltage signal by an IV conversion circuit.

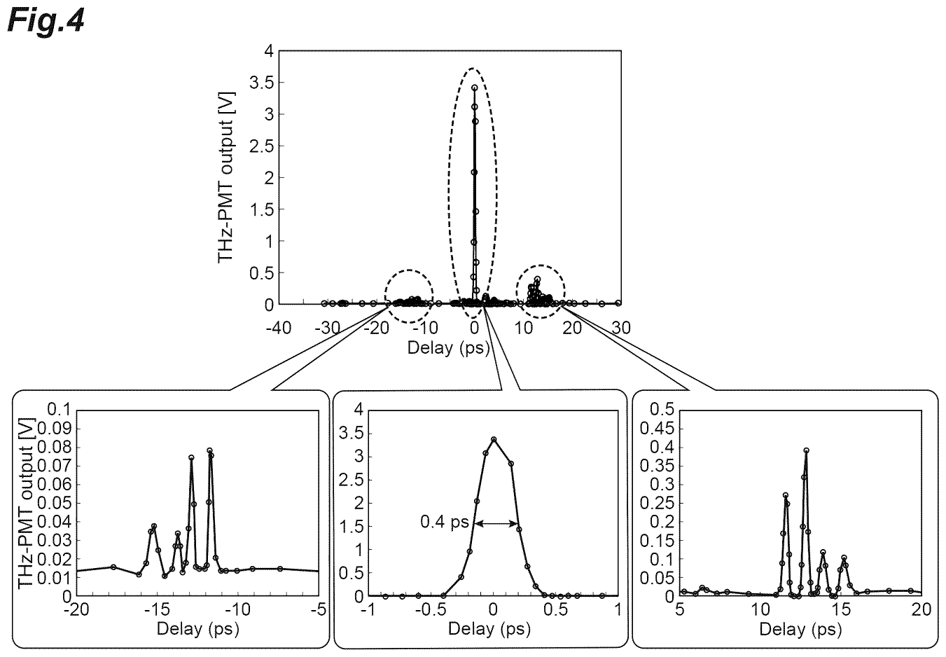

FIG. 4 is a graph showing a relationship between the intensity of the interference light measured by the interference intensity measurement unit 40 based on the electrical signal output from the photomultiplier tube 30 and the time difference Δt. As shown in this diagram, there is a peak of the intensity of the interference light at a position of the time difference of Δt=0, and there are also peaks of the intensity of the interference light respectively in a range of the time difference of Δt=−16 to −11 ps and in a range of the time difference of Δt=+11 to +16 ps. On the other hand, in the ranges of the time difference Δt other than the above peak ranges, the intensity of the interference light is very small.

The peak of the interference light intensity at the position of the time difference of Δt=0 is generated due to the interference of the first split light and the second split light without occurrence of multiple reflection, and a full width at half maximum is about 0.4 ps. It is confirmed that the interference light intensity can be obtained by using the photomultiplier tube 30.

The peaks of the interference light intensity respectively in the range of the time difference of Δt=−16 to −11 ps and in the range of the time difference of Δt=+11 to +16 ps are considered to be generated due to an etalon effect of the terahertz wave in the window portion 35 of the photomultiplier tube 30 or the substrate of the electron emission unit 31. The above peaks of the interference light intensity generated due to the etalon effect are sufficiently separated from the peak of the interference light intensity at the position of the time difference of Δt=0, and do not become noise.

For example, in the case in which the window portion 35 of the photomultiplier tube 30 is formed of synthetic quartz (with a refractive index of 1.5) and has a thickness of 1 mm, reflected pulses are generated at a time interval of 13.3 ps due to the etalon effect. In the case in which the substrate of the electron emission unit 31 of the photomultiplier tube 30 is formed of silicon (with a refractive index of 3.3) and has a thickness of 0.525 mm, reflected pulses are generated at a time interval of 12.0 ps due to the etalon effect.

The above time intervals (13.3 ps, 12.0 ps) of the reflected pulses generated by the etalon effect are sufficiently larger than the full width at half maximum (about 0.4 ps) of the peak of the interference light intensity at the position of the time difference of Δt=0. Therefore, there is no influence of the etalon effect of the terahertz wave in the window portion 35 of the photomultiplier tube 30 or the substrate of the electron emission unit 31.

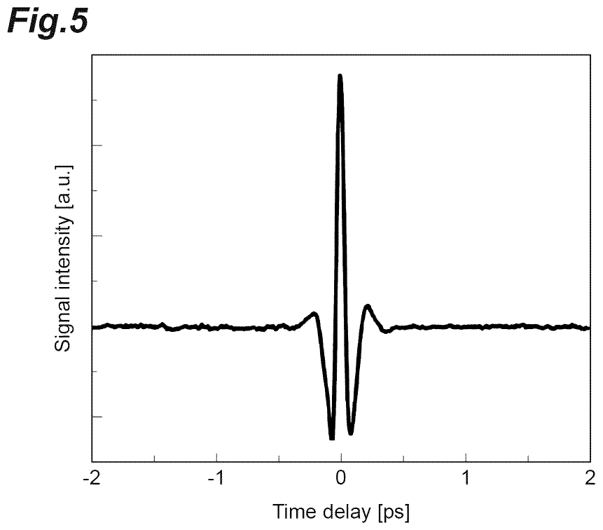

FIG. 5 is a graph showing a relationship between the intensity of the interference light and the time difference Δt which is shown in Non Patent Document 3. In Non Patent Document 3, a thermal detector is used. When FIG. 4 and FIG. 5 are compared, the dependence of the intensity of the interference light on the time difference Δt is largely different between the photomultiplier tube 30 and the thermal detector.

The dependence of the intensity of the interference light on the time difference Δt obtained in the case in which the photomultiplier tube 30 is used has a low correlation with the waveform of the terahertz wave incident on the photomultiplier tube 30. Therefore, simply performing the same processing as the conventional FTIR on the output signal from the photomultiplier tube 30 does not allow accurate analysis of the analysis target object.

This is considered to be because the relationship between the value of the electric field amplitude of the terahertz wave incident on the photomultiplier tube 30 and the value of the electrical signal output from the photomultiplier tube 30 is different between the photomultiplier tube 30 and the thermal detector. The present invention has been made based on the above findings of the present inventors.

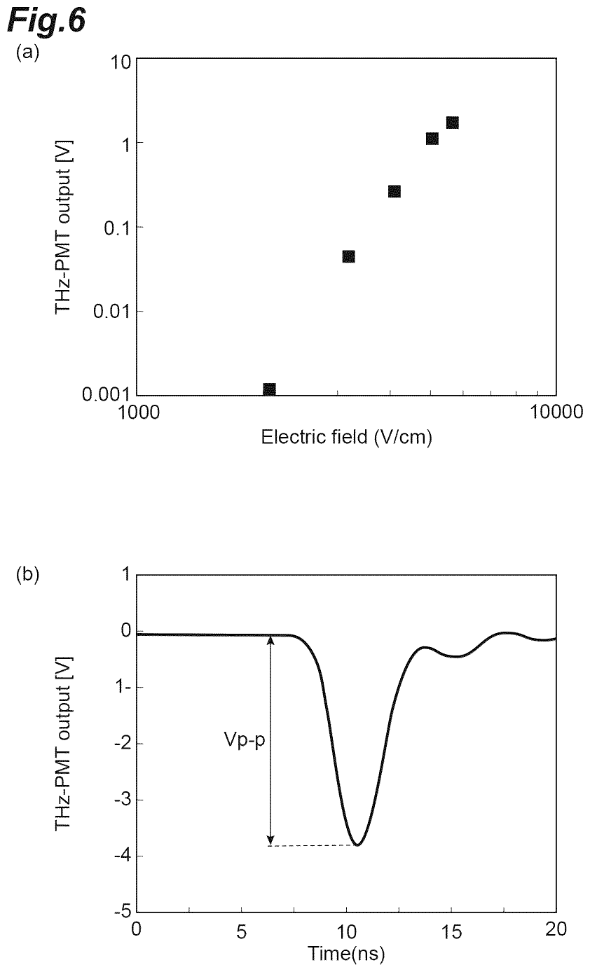

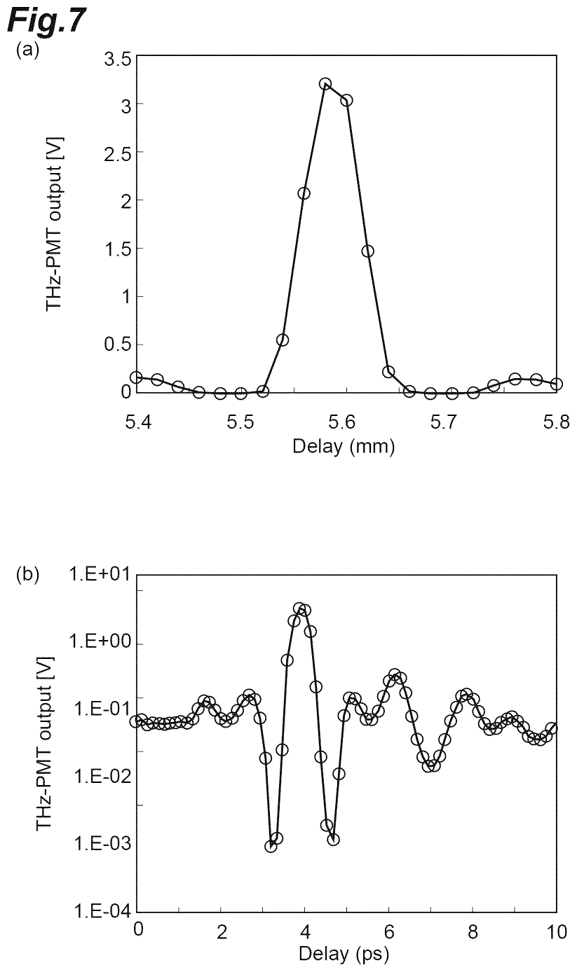

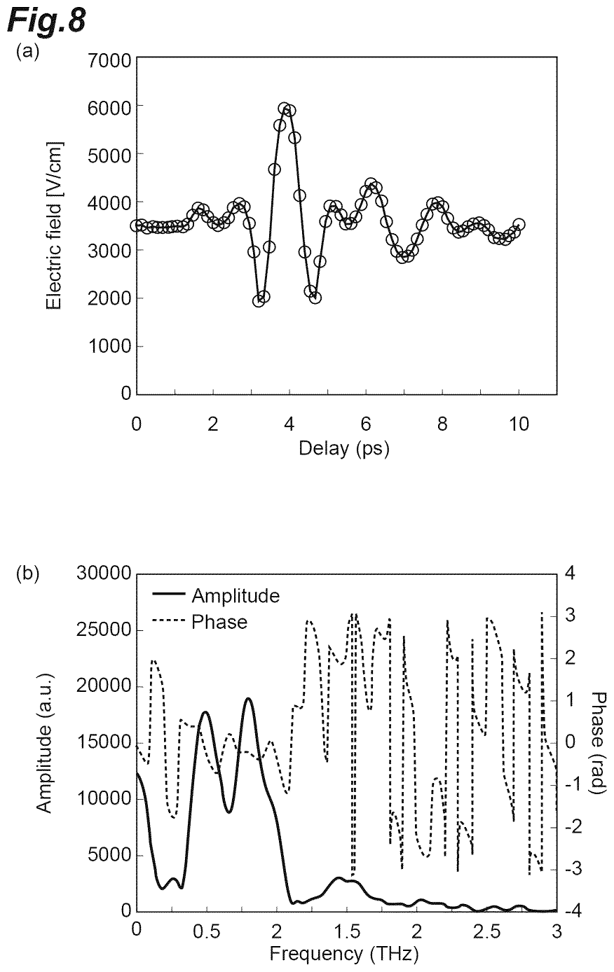

FIG. 6 to FIG. 8 are diagrams for describing the processing details performed by each of the interference intensity measurement unit 40, the electric field amplitude calculation unit 50, and the analysis unit 60. The interference intensity measurement unit 40 performs the processing described in (b) in FIG. 6 and (a) in FIG. 7. The electric field amplitude calculation unit 50 performs the processing described in (b) in FIG. 7 and (a) in FIG. 8. The analysis unit 60 performs the processing described in (b) in FIG. 8. In addition, the horizontal axis scale and the vertical axis scale in (a) in FIG. 6, and the vertical axis scale in (b) in FIG. 7 are logarithmic scales, and the other scales of the horizontal axis and the vertical axis are linear scales.

(a) in FIG. 6 is a graph showing the input-output characteristics of the photomultiplier tube 30. The horizontal axis indicates the electric field amplitude E of the light incident on the photomultiplier tube 30. The vertical axis indicates the electrical signal (the voltage signal V) output from the photomultiplier tube 30. As shown in this diagram, the input-output characteristics of the photomultiplier tube 30 are not linear. The above input-output characteristics of the photomultiplier tube 30 are obtained in advance.

(b) in FIG. 6 is a graph showing the time dependence of the voltage signal V output from the photomultiplier tube 30. The optical path length difference Δd is set to a certain value, and a temporal change of the voltage signal V output from the photomultiplier tube 30 is obtained. From this graph, the magnitude of the amplitude Vp-p of the voltage signal V is read.

(a) in FIG. 7 is a graph showing the dependence of Vp-p on the optical path length difference Δd. This graph is obtained by obtaining Vp-p for each value of the optical path length difference Δd.

(b) in FIG. 7 is a graph showing the dependence of Vp-p on the time difference Δt. There is a relationship of Δt=Δd/c between the optical path length difference Δd and the time difference Δt, and thus, the time difference Δt can be obtained from the optical path length difference Δd.

(a) in FIG. 8 is a graph showing the dependence of the electric field amplitude E of the interference light on the time difference Δt. By using the input-output characteristics of the photomultiplier tube 30 ((a) in FIG. 6), it is possible to convert from (b) in FIG. 7 to (a) in FIG. 8.

(b) in FIG. 8 is a diagram showing an amplitude spectrum and a phase spectrum of the electric field amplitude E of the interference light. This diagram is obtained by performing a Fourier transform on the dependence of the electric field amplitude E of the interference light on the time difference Δt.

As described above, in the present embodiment, the input-output characteristics of the photomultiplier tube 30 (the relationship between the electric field amplitude E of the light incident on the photomultiplier tube 30 and the electrical signal (the voltage signal V) output from the photomultiplier tube 30) are obtained in advance, and using the above, the magnitude of the amplitude Vp-p of the voltage signal V output from the photomultiplier tube 30 is converted into the electric field amplitude E of the interference light. By using the photomultiplier tube 30 and performing the above conversion, it is possible to perform the Fourier spectroscopy by the interference measurement using the terahertz wave rapidly and accurately.

As described above, the input-output characteristics ((a) in FIG. 6) of the photomultiplier tube 30 are not linear. The output value from the photomultiplier tube 30 may be described by a polynomial formula in which the electric field amplitude E of the light incident on the photomultiplier tube 30 is a variable, and further, it may also be described using the following Formula (1), which represents the efficiency of electron emission in the metasurface (Non Patent Document 4). This formula represents the relationship between the current J_{FN} emitted from the metasurface and the electric field amplitude E of the incident terahertz wave, and is called the Fowler-Nordheim relations (hereinafter referred to as the “FN equation”).

$$\begin{matrix}[ Formula 1 ] & \\ {J}_{FN} ( E ) = \frac{{a}_{FN}}{{t}_{F}^{2}} \frac{{( β E )}^{2}}{Φ} exp ( - \frac{{ν}_{F} {b}_{FN} {Φ}^{3 / 2}}{β E} ) & ( 1 )\end{matrix}$$

In the above FN equation, a_{FN} and b_{FN} are called FN constants, and have certain constant values. β is the field enhancement factor, which is about 400 in Non Patent Document 4. Φ is the work function of the material of the metasurface of the electron emission unit 31, which is 3.5 eV for gold. t_{F} and ν_{F} are constants. In the case in which the electric field amplitude of the incident terahertz wave is not large, the values of t_{F} and ν_{F} may be set to 1. In this case, the FN equation is represented by the following Formula (2).

$$\begin{matrix}[ Formula 2 ] & \\ {J}_{FN} ( E ) = {a}_{FN} \frac{{( β E )}^{2}}{Φ} exp ( - \frac{{b}_{FN} {Φ}^{3 / 2}}{β E} ) & ( 2 )\end{matrix}$$

The FN equation represents the relationship between the current J_{FN} emitted from the electron emission unit 31 of the photomultiplier tube 30 and the electric field amplitude E of the incident terahertz wave, and further, the relationship between the output value of the photomultiplier tube 30 and the electric field amplitude E of the incident terahertz wave can also be represented in the same manner.

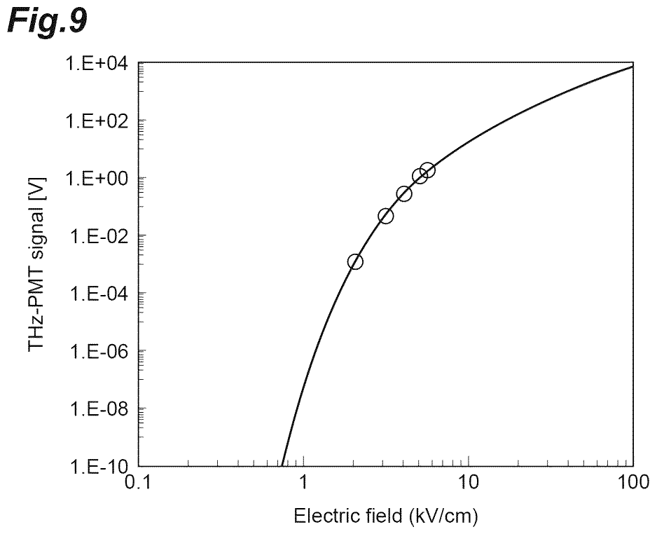

It is necessary to determine the respective values of a_{FN} and b_{FN} in the FN equation. For this purpose, the electric field amplitude E of the incident terahertz wave is set to each value, the output value V of the photomultiplier tube 30 is measured, and by performing fitting processing using the above measured values, the values of a_{FN} and b_{FN} can be determined. FIG. 9 is a graph showing the relationship (the FN equation) between the output value V of the photomultiplier tube 30 and the electric field amplitude E of the incident terahertz wave obtained by the fitting processing. In this diagram, five measured values are indicated by circles.

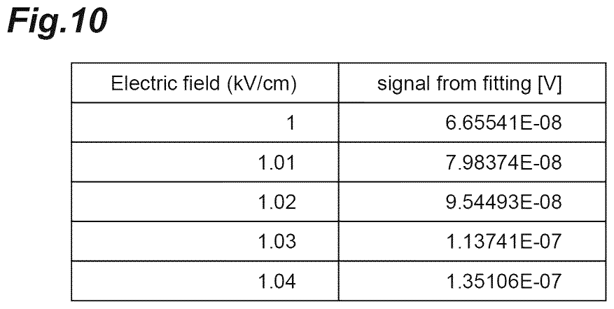

In order to obtain the electric field amplitude E of the incident terahertz wave from the output value V of the photomultiplier tube 30 by using the FN equation, the following procedure may be used. By the calculation using the FN equation, the output value V of the photomultiplier tube 30 is obtained for each value of the electric field amplitude E of the incident terahertz wave. FIG. 10 is a table describing a correspondence example between the electric field amplitude E of the incident terahertz wave and the output value V of the photomultiplier tube 30 obtained by the calculation using the FN equation. The electric field amplitude calculation unit 50 obtains the electric field amplitude E of the incident terahertz wave that is closest to the value of fitting from the actual output value V of the photomultiplier tube 30. In addition, the electric field amplitude E of the incident terahertz wave may be obtained by interpolation calculation.

The analysis unit 60 performs the analysis of the analysis target object S by performing the Fourier transform based on the dependence of the value of the electric field amplitude E of the interference light, obtained by the electric field amplitude calculation unit 50, on the value of the time difference Δt. Specifically, the process is as follows.

In the interference measurement apparatus 1A (FIG. 1) provided with the interference optical system 20A having the configuration of the Michelson interferometer, the terahertz wave passes through the analysis target object S twice. A phase refractive index of the analysis target object S is set to n(ω), an extinction coefficient of the analysis target object S is set to k(ω), and a complex refractive index of the analysis target object S is set to n′(ω)=n(ω)+i k(ω). ω is an angular frequency of the terahertz wave. When the frequency of the terahertz wave is set to f, ω=2πf. π is the circular constant. i is the imaginary unit.

The electric field amplitude of the interference light obtained in the case in which the analysis target object S is disposed is set to Eₛₐₘₚₗₑ(ω), and the electric field amplitude of the interference light obtained in the case in which the analysis target object S is not disposed is set to E_{ref}(ω), and the ratio T(ω) of the above values is represented by the following Formula (3). tₐₛ is the interface amplitude transmittance from air to the analysis target object S, and is represented by the following Formula (4). tₛₐ is the interface amplitude transmittance from the analysis target object S to air, and is represented by the following Formula (5). d is the thickness of the analysis target object S. c is the speed of light in a vacuum.

$$\begin{matrix}[ Formula 3 ] & \\ \begin{matrix}T ( ω ) = \frac{{E}_{sample} ( ω )}{{E}_{ref} ( ω )} = {( {t}_{as} {t}_{sa} )}^{2} exp [ 2 i \frac{\{ {n}^{′} ( ω ) - 1 \} ω d}{c} ] \\ = {( {t}_{as} {t}_{sa} )}^{2} exp [ - \frac{2 k ω d}{c} ] exp [ 2 i \frac{\{ n ( ω ) - 1 \} ω d}{c} ]\end{matrix} & ( 3 )\end{matrix}$$

$$\begin{matrix}[ Formula 4 ] & \\ {t}_{as} = \frac{2}{n ( ω ) + 1} & ( 4 )\end{matrix}$$

$$\begin{matrix}[ Formula 5 ] & \\ {t}_{sa} = \frac{2 n ( ω )}{n ( ω ) + 1} & ( 5 )\end{matrix}$$

By decomposing the above Formula (3) into a real part and an imaginary part, the following Formula (6) to Formula (8) are obtained. φ(ω) is the phase spectrum. α(ω) is the absorption coefficient. In the interference measurement apparatus 1A (FIG. 1), the analysis unit 60 can analyze the analysis target object S based on these formulas.

$$\begin{matrix}[ Formula 6 ] & \\ n ( ω ) = 1 + \frac{c}{2 ω d} ϕ ( ω ) & ( 6 )\end{matrix}$$

$$\begin{matrix}[ Formula 7 ] & \\ k ( ω ) = \frac{c}{2 ω d} [ ln {\{ \frac{4 n ( ω )}{n ( ω ) + 1} \}}^{2} - ln \{ T ( ω ) \} & ( 7 )\end{matrix}$$

$$\begin{matrix}[ Formula 8 ] & \\ α ( ω ) = \frac{2 ω k ( ω )}{c} & ( 8 )\end{matrix}$$

In the interference measurement apparatus 1B (FIG. 2) provided with the interference optical system 20B having the configuration of the Mach-Zehnder interferometer, the terahertz wave passes through the analysis target object S once. Therefore, instead of the above Formula (3), Formula (6), and Formula (7), the following Formula (9) to Formula (11) are used. In the interference measurement apparatus 1B (FIG. 2), the analysis unit 60 can analyze the analysis target object S based on these formulas.

$$\begin{matrix}[ Formula 9 ] & \\ \begin{matrix}T ( ω ) = \frac{{E}_{sample} ( ω )}{{E}_{ref} ( ω )} = {t}_{as} {t}_{sa} exp [ i \frac{\{ {n}^{′} ( ω ) - 1 \} ω d}{c} ] \\ = {t}_{as} {t}_{sa} exp [ - \frac{k ω d}{c} ] exp [ i \frac{\{ n ( ω ) - 1 \} ω d}{c} ]\end{matrix} & ( 9 )\end{matrix}$$

$$\begin{matrix}[ Formula 10 ] & \\ n ( ω ) = 1 + \frac{c}{ω d} ϕ ( ω ) & ( 10 )\end{matrix}$$

$$\begin{matrix}[ Formula 11 ] & \\ k ( ω ) = \frac{c}{ω d} [ ln \{ \frac{4 n ( ω )}{n ( ω ) + 1} \} - ln \{ T ( ω ) \} ] & ( 11 )\end{matrix}$$

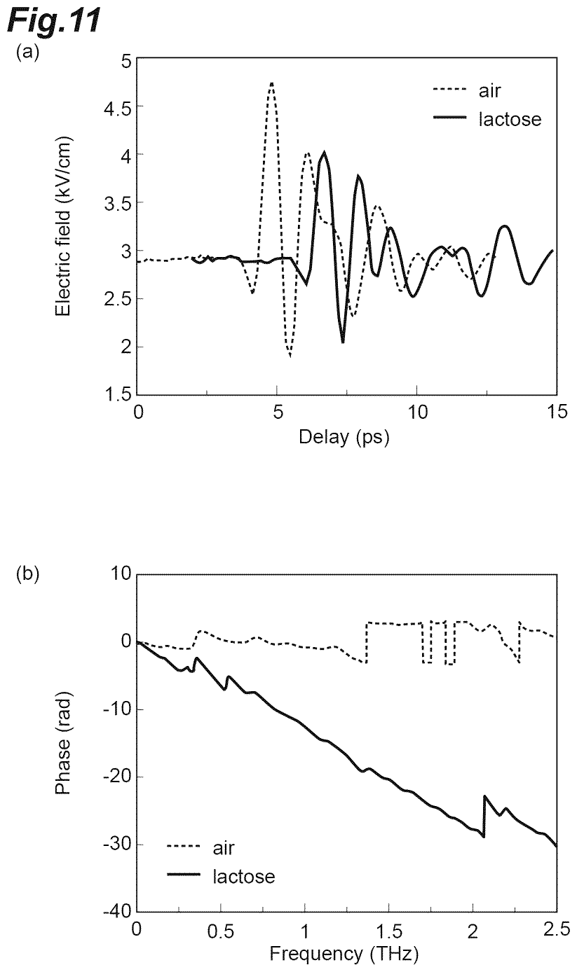

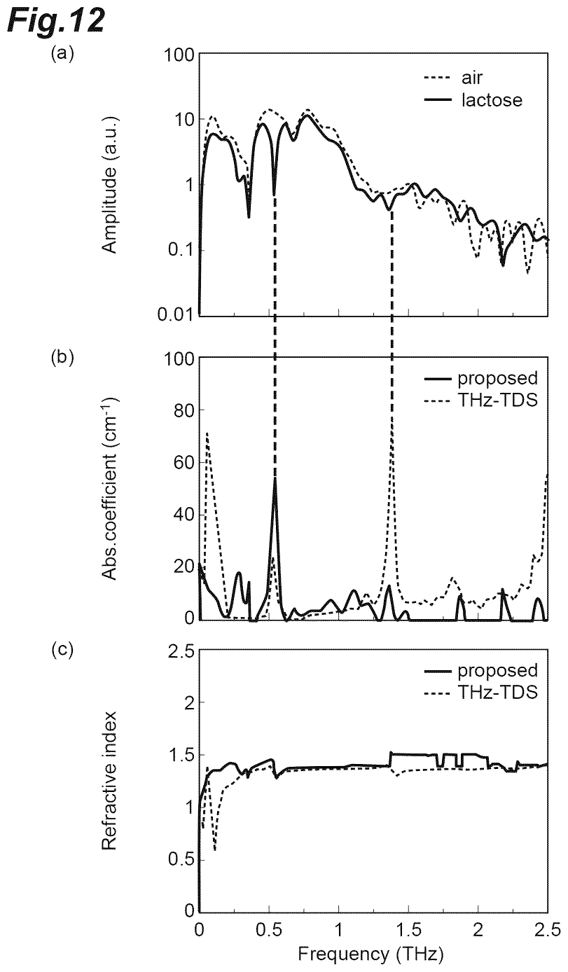

FIG. 11 and FIG. 12 include graphs showing an example of results of the measurement or the analysis. The graph shown in (a) in FIG. 11 is obtained by the electric field amplitude calculation unit 50. The respective graphs shown in (b) in FIG. 11 and (a) to (c) in FIG. 12 are obtained by the analysis unit 60.

(a) in FIG. 11 is a graph showing the dependence of the electric field amplitude E of the interference light on the time difference Δt. (b) in FIG. 11 is a graph showing the phase spectrum of the electric field amplitude E of the interference light. (a) in FIG. 12 is a graph showing the amplitude spectrum of the electric field amplitude E of the interference light. Each of the above graphs shows respectively the case in which the analysis target object S is disposed and the case in which the analysis target object S is not disposed. Lactose is used as the analysis target object S.

(b) in FIG. 12 is a graph showing the spectrum of the absorption coefficient α(ω). (c) in FIG. 12 is a graph showing the spectrum of the refractive index n(ω). The above graphs show the analysis results according to the present embodiment and the analysis results by using THz-TDS of the first related art.

As can be seen by comparing the analysis results by using the present embodiment and the analysis results by using THz-TDS of the first related art, the positions of the absorption peaks appearing in the spectrum of the absorption coefficient α(ω) coincide with each other. From the above fact, it can be said that the analysis target object S can be analyzed by using the present embodiment.

In the interference intensity measurement step, it is preferable that the interference intensity measurement unit 40 adjusts a measurement range at the time of the measurement of the intensity of the interference light based on the electrical signal output from the photomultiplier tube 30, so as to suppress saturation of the measured value of the intensity of the interference light, and suppress decrease of the measured value of the intensity of the interference light to a value of a noise level or less.

That is, when the optical path length difference Δd is changed, the magnitude of the amplitude Vp-p of the voltage signal V output from the photomultiplier tube 30 changes by about three orders of magnitude. In this case, in the case in which the measurement range in measuring the intensity of the interference light is fixed, the measured value of the intensity of the interference light may saturate, or the measured value of the intensity of the interference light may fall below the noise level. By adjusting the measurement range in measuring the intensity of the interference light, the interference intensity measurement unit 40 can suppress the saturation of the measured value of the intensity of the interference light, and can suppress the measured value of the intensity of the interference light from decreasing to the value of the noise level or less.

In the interference intensity measurement step, it is preferable that the interference intensity measurement unit 40 measures a magnitude of a specific frequency component obtained by performing the Fourier transform on the temporal waveform of the electrical signal output from the photomultiplier tube 30 as the intensity of the interference light.

That is, it is preferable that the interference intensity measurement unit 40 uses a FFT function provided in an oscilloscope. By using the FFT function, the value of the electrical signal can be logarithmically converted, and thus, even in the case in which the measurement range is not adjusted, it is possible to suppress the saturation of the measured value of the intensity of the interference light, and it is possible to suppress the decrease of the measured value of the intensity of the interference light to the value of the noise level or less. It is sufficient to measure the magnitude of the specific frequency component obtained by performing the Fourier transform as the intensity of the interference light.

In general, the lower the frequency, the higher the S/N ratio. A high frequency component depends on a type of the photomultiplier tube, and thus, it is preferable to analyze a low frequency component also from this point of view. In addition, at the frequency of 0 Hz (that is, the DC component), there is no significant difference due to the signal. Further, it is preferable to avoid the component which coincides with a repetition frequency of the pulsed light which is output from the light source 10. Therefore, it is preferable that the interference intensity measurement unit 40 measures, as the intensity of the interference light, a component of a frequency as low as possible, excluding the DC component and the repetition frequency of the pulsed light.

In the interference intensity measurement step, it is preferable that the interference intensity measurement unit 40 sets the dynamic range or the sensitivity at the time of the measurement of the intensity of the interference light based on the electrical signal by adjusting the applied voltage to the photomultiplier tube 30.

That is, as shown in FIG. 9, the output value V of the photomultiplier tube 30 increases nonlinearly with respect to the increase of the electric field amplitude E of the incident terahertz wave. As the electric field amplitude E of the incident terahertz wave increases, the increase of the output value V of the photomultiplier tube 30 tends to become less pronounced. Further, by changing the voltage value applied to the electron multiplier unit 32 of the photomultiplier tube 30, a sensitivity curve showing the relationship between the output value V of the photomultiplier tube 30 and the electric field amplitude E of the incident terahertz wave can be shifted in the horizontal direction.

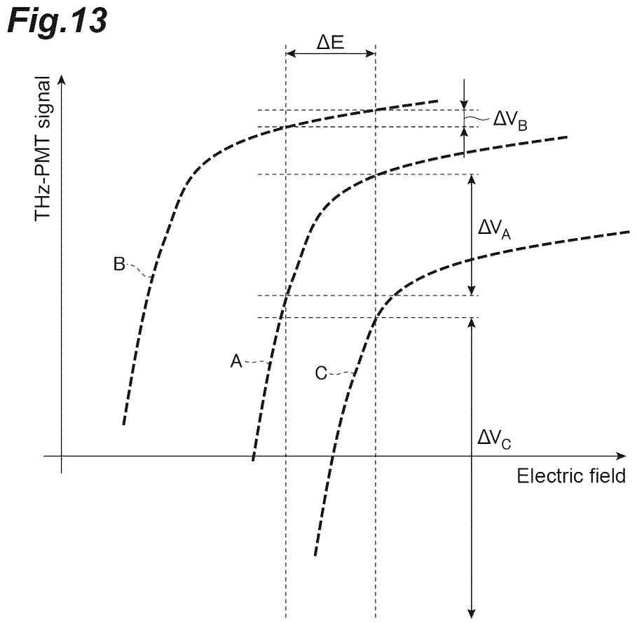

FIG. 13 is a graph showing a relationship between the output value V of the photomultiplier tube 30 and the electric field amplitude E of the incident terahertz wave. In this diagram, three sensitivity curves A to C with different voltage values applied to the electron multiplier unit 32 of the photomultiplier tube 30 are shown. The specification of the light source 10 is set to be fixed, and the change range ΔE of the electric field amplitude E of the incident terahertz wave is also set to be fixed.

In the case in which the applied voltage is increased with respect to the sensitivity curve A, the sensitivity curve is shifted to the left direction and becomes the sensitivity curve B. As compared with the change range ΔV_{A} of the output value V of the photomultiplier tube 30 in the sensitivity curve A, the change range ΔV_{B} of the output value V of the photomultiplier tube 30 in the sensitivity curve B becomes smaller, and thus, the dynamic range of the measurement can be increased, which is advantageous, for example, for the spectroscopic measurement using the photomultiplier tube 30.

On the other hand, in the case in which the applied voltage is decreased with respect to the sensitivity curve A, the sensitivity curve is shifted to the right direction and becomes the sensitivity curve C. As compared with the change range ΔV_{A} of the output value V of the photomultiplier tube 30 in the sensitivity curve A, the change range ΔV_{C} of the output value V of the photomultiplier tube 30 in the sensitivity curve C becomes larger, and thus, the measurement sensitivity can be increased, which is advantageous, for example, for the sensing using the photomultiplier tube 30.

As described above, the interference intensity measurement unit 40 can set the dynamic range or the sensitivity in measuring the intensity of the interference light based on the electrical signal, by adjusting the applied voltage to the photomultiplier tube 30.

The photomultiplier tube 30 may be a photomultiplier tube for measuring the incident light intensity, or may be a photomultiplier tube capable of imaging the incident light intensity distribution. In the case in which the electron multiplier unit 32 includes the microchannel plate (for example, an image intensifier), the imaging of the incident light intensity distribution is possible. By using the photomultiplier tube 30 described above, it becomes possible to perform analysis imaging of the analysis target object S.

The interference measurement apparatus and the interference measurement method are not limited to the embodiments and configuration examples described above, and various modifications are possible.

The interference measurement apparatus of a first aspect according to the above embodiment includes (1) a photomultiplier tube having sensitivity in a band of light including a terahertz wave, and for outputting an electrical signal having a value according to an incident light intensity; (2) a light source for outputting light in the band in which the photomultiplier tube has the sensitivity; (3) an interference optical system for splitting the light output from the light source into first split light and second split light, combining the first split light passed through an analysis target object and the second split light, and causing combined light to be incident on the photomultiplier tube, and in which an optical path length difference between the first split light and the second split light is variable; (4) an interference intensity measurement unit for measuring an intensity of interference light generated by the first split light and the second split light incident on the photomultiplier tube based on the electrical signal output from the photomultiplier tube; (5) an electric field amplitude calculation unit for, based on a relationship between a value of an electric field amplitude of the light incident on the photomultiplier tube and a value of the electrical signal output from the photomultiplier tube, converting a value of the intensity of the interference light measured by the interference intensity measurement unit into the value of the electric field amplitude, and obtaining the value of the electric field amplitude of the interference light for each value of a time difference corresponding to the optical path length difference; and (6) an analysis unit for analyzing the analysis target object by performing a Fourier transform based on a dependence of the value of the electric field amplitude of the interference light obtained by the electric field amplitude calculation unit on the value of the time difference.

In the interference measurement apparatus of a second aspect, in the configuration of the first aspect, the interference intensity measurement unit may adjust a measurement range in measuring the intensity of the interference light based on the electrical signal output from the photomultiplier tube, so as to suppress saturation of a measured value of the intensity of the interference light, and suppress decrease of the measured value of the intensity of the interference light to a value of a noise level or less.

In the interference measurement apparatus of a third aspect, in the configuration of the first or second aspect, the interference intensity measurement unit may measure a magnitude of a specific frequency component obtained by performing a Fourier transform on a temporal waveform of the electrical signal output from the photomultiplier tube as the intensity of the interference light.

In the interference measurement apparatus of a fourth aspect, in the configuration of any one of the first to third aspects, the interference intensity measurement unit may set a dynamic range or sensitivity in measuring the intensity of the interference light based on the electrical signal by adjusting an applied voltage to the photomultiplier tube.

In the interference measurement apparatus of a fifth aspect, in the configuration of any one of the first to fourth aspects, the photomultiplier tube may be capable of imaging an incident light intensity distribution, and the analysis unit may perform analysis imaging of the analysis target object.

The interference measurement method of a first aspect according to the above embodiment is a method for analyzing an analysis target object using (1) a photomultiplier tube having sensitivity in a band of light including a terahertz wave, and for outputting an electrical signal having a value according to an incident light intensity; (2) a light source for outputting light in the band in which the photomultiplier tube has the sensitivity; and (3) an interference optical system for splitting the light output from the light source into first split light and second split light, combining the first split light passed through the analysis target object and the second split light, and causing combined light to be incident on the photomultiplier tube, and in which an optical path length difference between the first split light and the second split light is variable, and the method includes (4) an interference intensity measurement step of measuring an intensity of interference light generated by the first split light and the second split light incident on the photomultiplier tube based on the electrical signal output from the photomultiplier tube; (5) an electric field amplitude calculation step of, based on a relationship between a value of an electric field amplitude of the light incident on the photomultiplier tube and a value of the electrical signal output from the photomultiplier tube, converting a value of the intensity of the interference light measured in the interference intensity measurement step into the value of the electric field amplitude, and obtaining the value of the electric field amplitude of the interference light for each value of a time difference corresponding to the optical path length difference; and (6) an analysis step of analyzing the analysis target object by performing a Fourier transform based on a dependence of the value of the electric field amplitude of the interference light obtained in the electric field amplitude calculation step on the value of the time difference.

In the interference measurement method of a second aspect, in the configuration of the first aspect, in the interference intensity measurement step, a measurement range in measuring the intensity of the interference light based on the electrical signal output from the photomultiplier tube may be adjusted, so as to suppress saturation of a measured value of the intensity of the interference light, and suppress decrease of the measured value of the intensity of the interference light to a value of a noise level or less.

In the interference measurement method of a third aspect, in the configuration of the first or second aspect, in the interference intensity measurement step, a magnitude of a specific frequency component obtained by performing a Fourier transform on a temporal waveform of the electrical signal output from the photomultiplier tube may be measured as the intensity of the interference light.

In the interference measurement method of a fourth aspect, in the configuration of any one of the first to third aspects, in the interference intensity measurement step, a dynamic range or sensitivity in measuring the intensity of the interference light based on the electrical signal may be set by adjusting an applied voltage to the photomultiplier tube.

In the interference measurement method of a fifth aspect, in the configuration of any one of the first to fourth aspects, the photomultiplier tube capable of imaging an incident light intensity distribution may be used, and in the analysis step, analysis imaging of the analysis target object may be performed.

### INDUSTRIAL APPLICABILITY

The present invention can be used as an interference measurement apparatus and an interference measurement method capable of performing Fourier spectroscopy by interference measurement using a terahertz wave rapidly and accurately.

### REFERENCE SIGNS LIST

1A, 1B—interference measurement apparatus, 10—light source, 20A, 20B—interference optical system, 21, 22—beam splitter, 23-26—mirror, 30—photomultiplier tube, 31—electron emission unit, 32—electron multiplier unit, 33—signal output unit, 34—housing, 35—window portion, 40—interference intensity measurement unit, 50—electric field amplitude calculation unit, 60—analysis unit, S—analysis target object.

1. An interference measurement apparatus comprising:
a photomultiplier tube having sensitivity in a band of light including a terahertz wave, and configured to output an electrical signal having a value according to an incident light intensity;
a light source configured to output light in the band in which the photomultiplier tube has the sensitivity;
an interference optical system configured to split the light output from the light source into first split light and second split light, combine the first split light passed through an analysis target object and the second split light, and cause combined light to be incident on the photomultiplier tube, and in which an optical path length difference between the first split light and the second split light is variable;
an interference intensity measurement unit configured to measure an intensity of interference light generated by the first split light and the second split light incident on the photomultiplier tube based on the electrical signal output from the photomultiplier tube;
an electric field amplitude calculation unit configured to, based on a relationship between a value of an electric field amplitude of the light incident on the photomultiplier tube and a value of the electrical signal output from the photomultiplier tube, convert a value of the intensity of the interference light measured by the interference intensity measurement unit into the value of the electric field amplitude, and obtain the value of the electric field amplitude of the interference light for each value of a time difference corresponding to the optical path length difference; and
an analysis unit configured to analyze the analysis target object by performing a Fourier transform based on a dependence of the value of the electric field amplitude of the interference light obtained by the electric field amplitude calculation unit on the value of the time difference.

2. The interference measurement apparatus according to claim 1, wherein the interference intensity measurement unit is configured to adjust a measurement range in measuring the intensity of the interference light based on the electrical signal output from the photomultiplier tube, so as to suppress saturation of a measured value of the intensity of the interference light, and suppress decrease of the measured value of the intensity of the interference light to a value of a noise level or less.

3. The interference measurement apparatus according to claim 1, wherein the interference intensity measurement unit is configured to measure a magnitude of a specific frequency component obtained by performing a Fourier transform on a temporal waveform of the electrical signal output from the photomultiplier tube as the intensity of the interference light.

4. The interference measurement apparatus according to claim 1, wherein the interference intensity measurement unit is configured to set a dynamic range or sensitivity in measuring the intensity of the interference light based on the electrical signal by adjusting an applied voltage to the photomultiplier tube.

5. The interference measurement apparatus according to claim 1, wherein the photomultiplier tube is capable of imaging an incident light intensity distribution, and the analysis unit is configured to perform analysis imaging of the analysis target object.

6. An interference measurement method for analyzing an analysis target object using:
a photomultiplier tube having sensitivity in a band of light including a terahertz wave, and configured to output an electrical signal having a value according to an incident light intensity;
a light source configured to output light in the band in which the photomultiplier tube has the sensitivity; and
an interference optical system configured to split the light output from the light source into first split light and second split light, combine the first split light passed through the analysis target object and the second split light, and cause combined light to be incident on the photomultiplier tube, and in which an optical path length difference between the first split light and the second split light is variable,
the method comprising:
an interference intensity measurement step of measuring an intensity of interference light generated by the first split light and the second split light incident on the photomultiplier tube based on the electrical signal output from the photomultiplier tube;
an electric field amplitude calculation step of, based on a relationship between a value of an electric field amplitude of the light incident on the photomultiplier tube and a value of the electrical signal output from the photomultiplier tube, converting a value of the intensity of the interference light measured in the interference intensity measurement step into the value of the electric field amplitude, and obtaining the value of the electric field amplitude of the interference light for each value of a time difference corresponding to the optical path length difference; and
an analysis step of analyzing the analysis target object by performing a Fourier transform based on a dependence of the value of the electric field amplitude of the interference light obtained in the electric field amplitude calculation step on the value of the time difference.

7. The interference measurement method according to claim 6, wherein, in the interference intensity measurement step, a measurement range in measuring the intensity of the interference light based on the electrical signal output from the photomultiplier tube is adjusted, so as to suppress saturation of a measured value of the intensity of the interference light, and suppress decrease of the measured value of the intensity of the interference light to a value of a noise level or less.

8. The interference measurement method according to claim 6, wherein, in the interference intensity measurement step, a magnitude of a specific frequency component obtained by performing a Fourier transform on a temporal waveform of the electrical signal output from the photomultiplier tube is measured as the intensity of the interference light.

9. The interference measurement method according to claim 6, wherein, in the interference intensity measurement step, a dynamic range or sensitivity in measuring the intensity of the interference light based on the electrical signal is set by adjusting an applied voltage to the photomultiplier tube.

10. The interference measurement method according to claim 6, wherein the photomultiplier tube capable of imaging an incident light intensity distribution is used, and in the analysis step, analysis imaging of the analysis target object is performed.
